(19) United States
(12) Patent Application Publication
(10) Pub. No.: US 2026/0161273 A1
(43) Pub. Date: Jun. 11, 2026

(54) AGENT ACTION MODELLING USING ANNOTATIONS FOR VISION LANGUAGE MODEL INPUT

(71) Applicant: GOOGLE LLC, Mountain View, CA (US)

(72) Inventor: Dongeek Shin, San Jose, CA (US)

(21) Appl. No.: 18/969,810

(22) Filed: Dec. 5, 2024

(51) Int. Cl. G06F 3/04845; G06F 3/0486; G06T 11/60; G06V 10/25

(52) U.S. Cl. CPC G06F 3/04845; G06F 3/0486; G06T 11/60; G06V 10/25

(57) ABSTRACT

At least using a visual input scheme for a VLM that relies on a set-of-mark strategy and indexing so that the visual-to-UI-anchor association is clear for the vision language model (VLM), thus opening up an action model with a high accuracy. The VLM can thus be used to control a graphical user interface (GUI) based on natural language queries input by a user. The natural language query indicates a target task to be performed via the GUI. The natural language query is input into a VLM alongside an annotated image of the GUI that contains visual indications of the interactable elements, each with a respective index value. The VLM processes this input to generate data indicating one or more actions to be taken via the GUI and, for an action, a corresponding index of the interactable element in the GUI at which the action is to be taken.

### BACKGROUND

Various generative models have been proposed that can be used to process natural language (NL) content, vision and/or other input(s), to generate output that reflects generative content that is responsive to the input(s). For example, vision language models (VLM(s)) have been developed that can be used to process NL content and visual content (and/or other input(s)), to generate VLM output that that reflects NL content and/or other content that is responsive to the input(s). For instance, a VLM can be used to process NL content of “What type of animal is shown in this picture” and visual content in the form of an image, to generate VLM output that reflects several responsive NL sentences such as: “The image shows a cat”. However, current utilizations of generative models suffer from one or more drawbacks.

As one example, VLMs can be utilized as part of a text-based dialogue application, generating responses to textual inputs/queries provided by a user of the application. However, complex input prompts, for example prompts that request that a task be performed via a user interface or that require tasks to be performed via a user interface to generate a response, can be difficult for the VLM to handle effectively.

### SUMMARY

Implementations disclosed herein are directed to at least using a visual input scheme for a VLM that relies on a set-of-mark strategy and indexing so that the visual-to-UI-anchor association is clear for the vision language model (VLM), thus opening up an action model with a high accuracy. The VLM can thus be used to control a graphical user interface (GUI) based on natural language queries input by a user. The natural language query indicates a target task to be performed via the GUI. The natural language query is input into a VLM alongside an annotated image of the GUI that contains visual indications of the interactable elements, each with a respective index value. The VLM processes this input to generate data indicating one or more actions to be taken via the GUI and, for an action, a corresponding index of the interactable element in the GUI at which the action is to be taken. The action can then be performed automatically at the indicated interactable element of the GUI. For complex tasks, the method may be iterated, with the annotated GUI being updated once the action for that iteration has been performed.

For example, a user can request a search for a particular topic to be performed via a web browser. An annotated image of the current web browser GUI is generated, for example from the Document Object Model (DOM) of the currently displayed web page, which indicates each of the interactable elements in the current web browser GUI and indexes them. The annotated image of the current web browser GUI is input into a multi-modal model (e.g., a VLM) along with the user request. The multi-modal model processes this input data and outputs an indication of the action to be taken, e.g., enter the search topic as text, and an index corresponding to the search bar element of the current web browser GUI. This output data is converted into instructions for the user interface that cause the search topic to be automatically entered into the search bar. An annotated image of the updated web browser GUI is then generated and input into the multi-modal model along with the user request. The multi-modal model processes this input data and outputs an indication of the action to be taken, e.g., perform a click on the indexed interactable element, and an index corresponding to a “search” button in the web browser GUI. This output data is converted into instructions for the user interface that cause the search button to be clicked, and the search performed.

In these, and other, manners, the multi-modal model is primed to generate actions through interactable elements of the GUI in a reliable and efficient manner. The use of indices for interactable elements has the effect of “reducing the output space complexity” and thus the net reliability (for example, measured in terms of task completion recall and precision) of this approach is higher than conventional methods that rely on pixel locations in the GUI. This can allow efficient and accurate control of a GUI via natural language input, e.g., via voice commands.

In some implementations, an LLM or VLM can include at least hundreds of millions of parameters. In some of those implementations, the LLM/VLM includes at least billions of parameters, such as one hundred billion or more parameters. In some additional or alternative implementations, an LLM/VLM is a sequence-to-sequence model, is Transformer-based, and/or can include an encoder and/or a decoder. One non-limiting example of an LLM is GOOGLE'S Pathways Language Model (PaLM). Another non-limiting example of an LLM is GOOGLE'S Language Model for Dialogue Applications (LaMDA). One non-limiting example of a VLM is GOOGLE'S GEMINI Model. However, and as noted, it should be noted that the LLMs/VLMs described herein are one example of generative machine learning models are not intended to be limiting.

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts an overview of an example method of controlling a user interface using a VLM.

FIG. 3 depicts an overview of an example iterative method of controlling a user interface using a VLM.

FIG. 4 illustrates an example of an annotated image of a graphical user interface.

FIG. 5 illustrates a flow diagram of an example method for controlling a user interface using a VLM.

FIG. 6 depicts an example architecture of a computing device, in accordance with various implementations.

### DETAILED DESCRIPTION

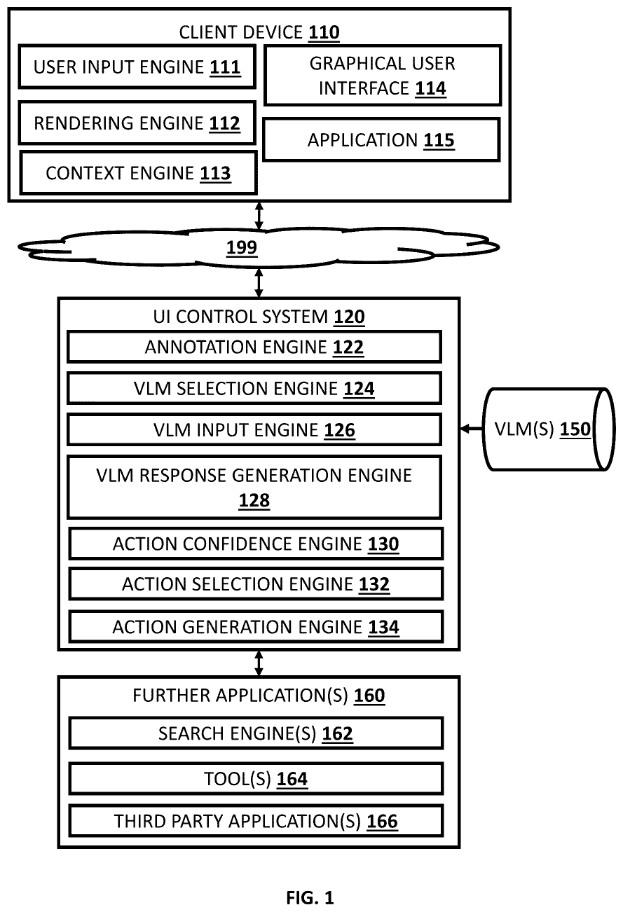

Turning now to FIG. 1, a block diagram of an example environment 100 that demonstrates various aspects of the present disclosure, and in which implementations disclosed herein can be implemented is depicted. The example environment 100 includes a client device 110, a user interface (UI) control system 120, and one or more further applications 160 (i.e. applications external to a VLM or a dialogue application executed on the client device 110). Although illustrated separately, in some implementations all or aspects of the UI control system 120 and all or aspects of the one or more further applications 160 can be implemented as part of a cohesive system.

In some implementations, all or aspects of the UI control system 120 can be implemented locally at the client device 110. In additional or alternative implementations, all or aspects of the UI control system 120 can be implemented remotely from the client device 110 as depicted in FIG. 1 (e.g., at remote server(s)). In those implementations, the client device 110 and the UI control system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker having a display, a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which queries can be submitted and/or NL based summaries and/or other response(s) to the query can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system (OS), or can be an application that is integrated as part of the operating system functionality. The application 115 can interact with the UI control system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of a query described herein can be a query that is formulated based on user input provided by a user of the client device 110 and detected via user input engine 111. For example, the query can be a typed query that is typed via a physical or virtual keyboard, a suggested query that is selected via a touch screen or a mouse, a spoken voice query that is detected via microphone(s) of the client device, or an image query that is based on an image captured by a vision component of the client device.

In various implementations, the client device 110 can include a rendering engine 112 that is configured to provide content (e.g., an NL based summary) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. As an example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based summary) for an implied query.

In various implementations, the client device 110 can include one or more graphical user interfaces (GUI(s)) 114. A GUI 114 is configured to provide a visual user interface to the user via a display of the client device 110 through which the user can interact with an application 115 associated with the GUI 114. One or more applications 115 on the user device 110 may each be associated with a respective GUI 114. For example, a GUI 114 may be associated with an operating system of the user device 110. A GUI 114 may be associated with a web browser of the user device 110. Many other examples are possible. A GUI 114 comprises one or more interactable elements (e.g., icons, links, buttons, text input boxes, scroll bars, etc.) through which a user can interact (e.g., through touch, typing, a mouse cursor, etc.) with the application 115 associated with the GUI 114.

Further, the client device 110 and/or the UI control system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

UI control system 120 is illustrated as including an annotation engine 122, a VLM selection engine 124, a VLM input engine 126, a VLM response generation engine 128, an action confidence engine 130, and an action generation engine 134. Some of the engines can be omitted/combined in various implementations. In some implementations, the engines of the UI control system 120 are distributed across one or more computing systems. In general, the UI control system 120 is configured to receive a natural language request for a task to be performed via the GUI 114 of the client device 110, and to process the natural language request and an (annotated) image of the GUI 114 to generate an action to be taken via the GUI in furtherance of the task.

The annotation engine 122 can, in response to receiving a query, generate an annotated image of a GUI 114. The annotated image of a GUI 114 comprises an image of the GUI in which one or more interactable elements are indicated and each associated with a respective index. The respective index for each interactable element is indicated in the annotated image. For example, in some implementations each interactable element is indicated with a respective numbered/lettered bounding box. The annotation engine 122, in some implementations, generates the annotated image of the GUI 114 from structural information relating to the layout of the GUI 114, e.g., data indicating the relative positions of the elements of the GUI. In some examples, the structural information comprises a document object model (DOM) tree for the GUI.

The VLM selection engine 124 can, in response to receiving a query, determine which, if any, of multiple generative model(s) (VLM(s) 150 and/or other multi-modal generative model(s)) to utilize in generating cations responsive to the user query. For example, the VLM selection engine 124 can select none, one, or multiple generative model(s) to utilize in generating action(s) in furtherance of the task indicated by the user query. The VLM selection engine 124 can optionally utilize one or more classifiers and/or rules (not illustrated).

The VLM input engine 126 can, in response to receiving a query, generate VLM input that is to be processed using a VLM in generating a GUI action in response to the query. As described herein, such content can include query content that is based on the query and/or additional content, such as contextual information derived from the context engine.

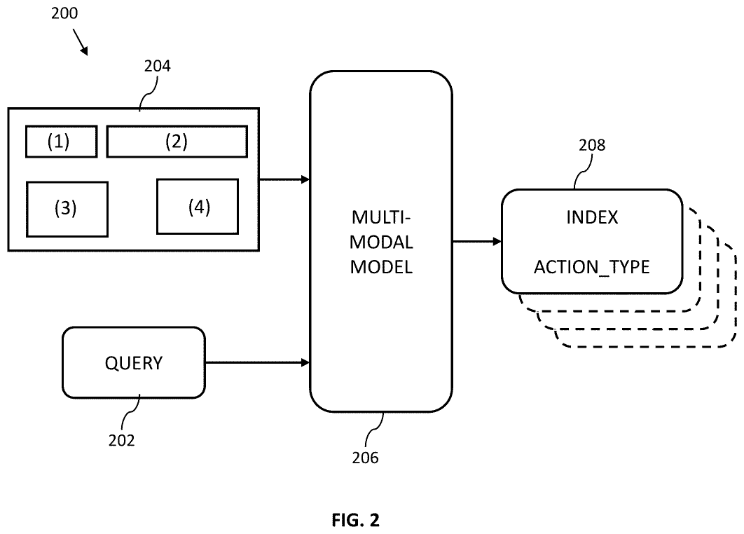

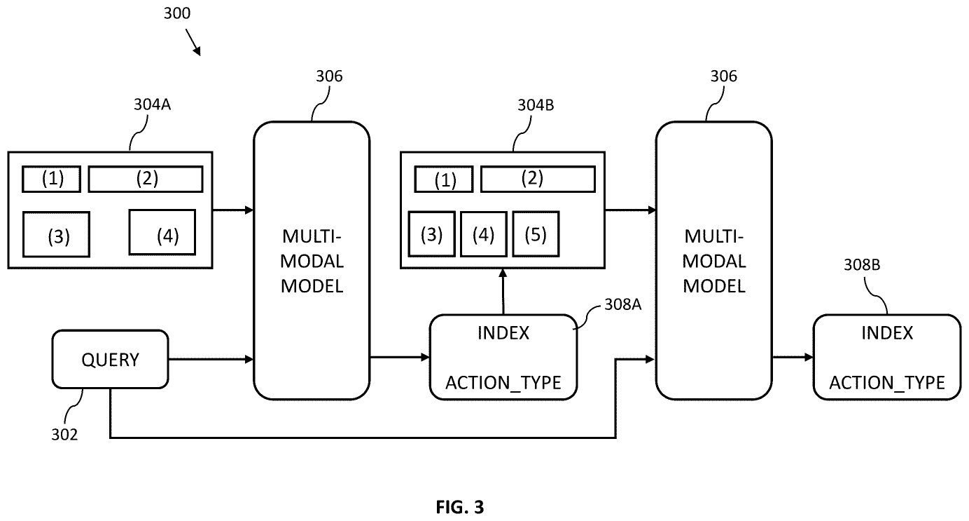

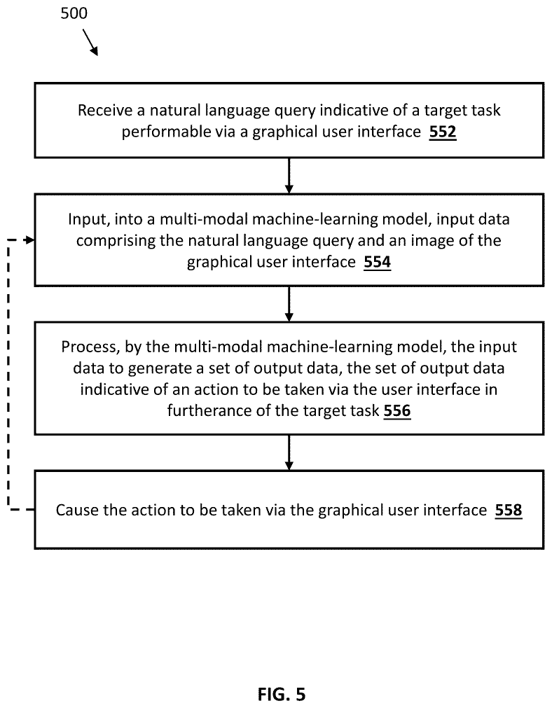

The VLM response generation engine 128 can process VLM input that is generated by the VLM input engine 126, using a VLM to generate output data indicating one or more actions to be performed via the GUI in furtherance of the task. The output data, for example, comprises data indicating an action type (e.g., a click, a text entry, etc.) and an index of an interactable element in the GUI at which to perform the action. In some examples, the output data comprises a plurality of candidate actions and respective indices. In various implementations, the VLM response generation engine 128 can perform all or aspects of the multi-modal model(s) 206, 306 of FIG. 2 and FIG. 3 and/or blocks 554, 556 of method 500 of FIG. 5. The VLM response generation engine 128 can utilize one or more VLMs 150.

The action confidence engine 130 can generate one or more confidence scores for the output data of the VLM. For example, for each candidate action generated by the VLM response generation engine 128, the action confidence engine 130 generates a respective confidence score indicating a likelihood/probability that a respective candidate action is in furtherance of the target task.

The action selection engine 132 can select one or more actions from the set of candidate actions output by the VLM response generation engine 128. The action selection engine 132 can, in some examples, select the candidate action with the highest confidence score for performance by the user device 110. In some examples, the action selection engine 132 can compare the confidence scores of the candidate actions to a threshold score. The selected action is selected from the set of candidate actions with a confidence score that exceeds the threshold score. If no candidate action has a confidence score that exceeds the threshold score, the action selection engine 132 may select a default action, e.g., an action that outputs a request for further information via the GUI 114 of the client device 110.

The action generation engine 134 can convert the action selected by the action section engine into one or more commands for the GUI 114 that, when implemented by the client device, 110, cause the client device to perform the selected action.

The set of external applications 160 is illustrated as including one or more search engines 162 and one or more tools 164. Some of the engines can be omitted in various implementations. Further external applications may also be included in the set of external applications 160. One or more of the external applications may be associated with a respective GUI. The one or more further applications may be executed in a secure environment.

The one or more search engines 162 can receive a search request from the UI control system 120 and/or client device 110 and perform a search operation on a search space. The search engine can return one or more search results to the UI control system 120 and/or the client device 110. The one or more search engines may comprise an internet search engine.

The one or more tools 164 include, for example, applications that can be used to perform creative tasks, such as one or more image tools for creating and/or editing images, one or more document tools for reading, writing and/or editing documents, one or more audio tools for listening to, creating and/or editing audio. Many other examples are possible.

The one or more third party applications 166 can include applications that are hosted and/or controlled by a third party for providing access to services that they provide. Examples of such third party applications include, but are not limited to: booking applications; e-commerce applications; translation applications; and/or the like.

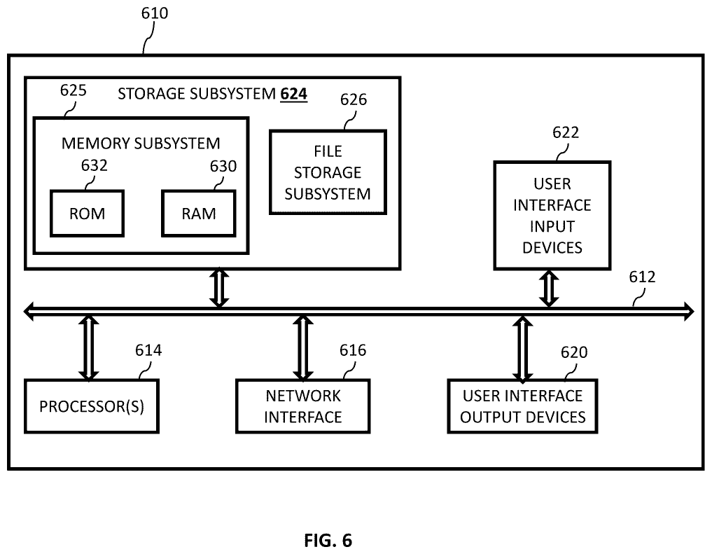

Turning now to FIG. 2, FIG. 2 illustrates an overview of an example method 200 of controlling a user interface using a VLM. The method 200 may be performed by one or more computing systems, such as the UI control system 120 of FIG. 1 and/or the computing system described herein with respect to FIG. 6.

A natural language query 202 is received from a user via a user device. The natural language query 202 indicates a target task to be performed via the GUI of the user device. The natural language query 202 is input into a multi-modal model 206 (e.g., a VLM) along with an annotated image 204 of the GUI of the user device. The annotations in the annotated image 204 indicate the locations of interactable elements of the GUI, and assign a respective index to each of the interactable elements. The multi-modal model 206 processes the input query 202 and the annotated image 204 to generate a set of output data 208 that comprises an action to be taken through the GUI and the index of an interactable element of the GUI at which the action is to be taken. The output data 208 can be converted to instructions for the user device that cause the user device to execute the identified action at the location corresponding to the index.

The natural language query 202 can be received via a user interface of the user device. The natural language query 202 is, in some examples, received in the form of an input text query. The natural language query 202 can, for example, originate as text input manually by a user of the user device. Alternatively, or additionally, the natural language query 202 can originate from a spoken input to the user device, e.g. a spoken query input after invoking a user application. The spoken input is converted to the natural language query 202 by a speech-to-text engine running on the client device (either as part of a user application, or accessible by a user application). The natural language query 202 is, in some examples, part of an ongoing human-computer dialogue, e.g. a sequence of input queries (with or without corresponding input images) and their corresponding responses to the application.

The natural language query 202 can reference the target task explicitly or implicitly. For example, the natural language query 202 may be an explicit request to perform a task, e.g., “Please open my documents folder” or “Search for local restaurants”. Alternatively, the natural language query 202 may be an implicit request to perform a task, e.g., “What is my current memory usage” implicitly refers to the task of accessing and retrieving a device memory usage.

The annotated image 204 comprises an image of a GUI of the user device and one or more annotations that each indicate a respective interactable element of the GUI. Each annotation includes a respective index, e.g., a (unique) numerical or alphabetical index. The annotated image 204 of the GUI, in some examples, comprises at least a portion of the GUI that is not currently visible via a display of the user device. For example, the annotated image 204 of the GUI can include a full image of an operating system GUI, an application GUI, a document, a webpage/browser or the like, e.g., portions that are not visible on the display of the user device, but that could be reached by scrolling or swiping. As a further example, the annotated image 204 of the GUI may include a GUI that is not currently visible on the display of the user device, e.g., is currently minimized and/or running as a background process. The GUI is, in some examples, the GUI of an application running on the user device. In some examples, the GUI is the operating system GUI of the user device.

Interactable elements of the GUI are GUI elements that a user can interact with, for example by clicking, touching, typing into, selecting, highlighting or the like. Examples of such interactable elements include: text boxes (such as search bars or the like); GUI icons; hyperlinks; toolbar elements; command line interfaces; sections of copyable text; selectable images, and/or the like. Such interactable elements can typically be identified from structural information relating to the layout of the GUI, i.e., data that indicates the positions of GUI elements when displayed. An example of such structural data for a webpage is a Document Object Model (DOM). The annotations for the annotated image 204 are, in some examples, generated using the structural data of the GUI, e.g., the structural data may be edited to insert the indications of the interactable elements and their corresponding indices.

In some implementations, the annotations comprise one or more bounding boxes for interactable elements of the GUI. The bounding boxes are indexed with numbers, letters, or alphanumeric sequences.

As an example, the GUI can be the home screen of a smartphone OS comprising a plurality of selectable icons that a user can interact with, e.g., by touch, and a drag-down menu that the user can interact with by swiping. In such an example, the annotated image of the GUI 204 comprises a respective bounding box around each selectable icon and a bounding box for the GUI area from which the user can pull down the drag-down menu. Each bounding box is labelled with a numerical index, for example contained within the bounding box.

As a further example, the GUI can be a webpage, e.g., a webstore page, that comprises one or more selectable links, one or more navigation icons, a search bar for inputting a text search, and a button for initiating a search on the input text. In such an example, the annotated image of the GUI 204 comprises a respective bounding box around each of the one or more selectable links, each of the one or more navigation icons, the search bar, and the button for initiating a search on the input text, each with a respective index assigned to them.

Generation of the annotated image 204 is, in some examples, initiated once the user has input the input query 202. In some such examples, the system performing the method 200 determines whether the input query 202 relates to a target task (e.g., using a suitably prompted LLM or a classification model), and initiates the generation of the annotated image 204 in response to a positive determination. This can prevent unnecessary generation of annotated GUI images 204 when the input query 202 does not relate to a target task.

Alternatively, in some examples generation of the annotated image 204 is initiated as soon as a user starts inputting a query 202. This can reduce latency when the user submits a query that relates to a target task.

Alternatively, in some examples generation of the annotated image 204 is initiated during entry of the input query by the user in response to the system determining that a partially complete input query is likely to relate to a target task, e.g., has a probability of relating to a target task (as determined by some model) that is above a threshold probability value. Such an approach can balance the latency of the response with the amount of compute required.

The multi-modal model 206 is a machine-learning model that takes input data in at least two modalities, i.e., in at least a natural language modality and a vision modality. An example of such a multi-modal model 206 is a VLM. The multi-modal model 206 has, in some examples, a transformer-based architecture, e.g., comprises one or more transformer layers.

The output of the multi-modal model is one or more sets of output data 208. A set of output data 208 comprises an indication of an action type (e.g., a token representing an action that can be taken via the GUI) and an index of the interactable element at which the action should be taken. In some examples, a set of output data 208 further comprises a confidence score indicative of how likely it is that the identified action would further the target task. An action can be selected from the one or more sets of output data 208 based on this confidence score, e.g., the action in the set of output data 208 with the highest confidence score can be selected to be implemented. In some examples, a threshold confidence score is applied, i.e., the selected action is selected from the sets of output data 208 that have a higher confidence score than the threshold confidence score. If no set of output data 208 has a higher confidence score than the threshold value, a default action may be performed, e.g., outputting a request to the user for a user interaction with the GUI, clarification and/or further input data 202.

The indication of an action type contained in a set of output data 208 comprises data that identifies an action from a possible set of actions that are performable via the GUI. Such data may, for example, be in the form of a token or other identifier that is associated with an action type. The set of possible actions, in some examples, comprises a set of atomic action, i.e., individual actions that can be performed via the GUI that cannot be broken down into a sequence of smaller actions. The set of atomic actions may be “interface complete”, i.e., any action that can be taken via the GUI can be built up from the set of atomic actions. Examples of such actions include: a click; a double-click; entering/typing text; moving a cursor; an input touch, drag or other gesture; performing a copy, cut or paste action; and/or the like.

In some examples, the set of possible actions further comprises one or more compound actions, i.e., an action that is a sequence of a plurality of atomic actions. Such compound actions allow a complex action to be performed based on a single output from the multi-modal model.

In some examples, the set of possible actions may comprise a set of one or more interrupt actions that cause a request/response to be output via the graphical user interface to the user. For example, the set of interrupt actions can comprise one or more requests to the user to manually perform an action through the GUI, e.g., to input sensitive data, such as login information. The method 200 may, in some examples, resume after the user has manually performed the action. Alternatively, or additionally, the set of interrupt actions can comprise one or more termination actions, e.g., that provide an output indicating that the task has been completed or that the system has failed to perform the task.

The multi-modal model 206 is, in some examples, based on a fine-tuned VLM model. The VLM model has been finetuned on a training dataset comprising a set of training examples, each training example containing one or more augmented GUI images 204, a user query 202 and one or more ground truth sets of output data (i.e., actions and respective indices) that each correspond to a respective augmented GUI image. The VLM model is finetuned to predict a set of output data given an input query and augmented GUI image. Prior to fine-tuning, the VLM model may have been pretrained on generic VLM tasks using any of the methods known in the art.

The output of the multi-modal model 206 can be used to generate instructions for the system to perform the identified action at the indexed location. For example, the output of the multi-modal model 206 can be converted to API instructions, e.g., using a predefined mapping of actions to API commands.

As an example, a system, e.g., a user device, is on a home screen of its operating system, on which a plurality of shortcuts to respective folders are displayed. The user inputs a query, e.g., via spoken language, stating “Please open my pictures folder”. The system inputs a natural language representation of the query into a VLM alongside an annotated image of the home screen. The annotated image comprises a plurality of bounding boxes that each correspond to a respective icon on the home screen (or to other interactable elements, such as a “Start” menu button). The system inputs the query and annotated image into a VLM, which uses the to generate a set of output data indicating the action “double-click” and the index of the shortcut corresponding to the pictures folder. The output data is converted to system instructions that cause the system to perform a double-click action at the location of the index in order to open the shortcut located there.

Turning now to FIG. 3, FIG. 3 illustrates an overview of an example iterative method of controlling a user interface using a VLM. The method may be performed by one or more computing systems, such as the system described herein with respect to FIG. 6.

In some examples, a target task indicated in the input query 302 requires a sequence of actions to be performed in order to be completed. In the example shown in FIG. 3, the target task requires a sequence of two actions to be taken, though in general the sequence can be of any length (in some examples, up to some threshold maximum value).

The first iteration of the method proceeds as described in relation to FIG. 2. A natural language query 302 is received from a user via a user device. The natural language query 302 indicates a target task to be performed via the GUI of the user device. The natural language query 302 is input into a multi-modal model 306 (e.g., a VLM) along with an initial annotated image 304A of the GUI state of the user device. The multi-modal model 306 processes the input query 302 and the annotated image 304A to generate a first set of output data 308A that comprises a first action to be taken through the GUI and the index of an interactable element of the GUI at which the first action is to be taken. The first set of output data 308A can be converted to instructions for the user device that cause the user device to execute the identified first action at the location corresponding to the index.

Executing the action results in an updated GUI. For example, clicking a hyperlink in the GUI will load the linked page. As another example, opening a folder will result in the files stored in the folder being displayed via the GUI.

At the second (and subsequent) iteration(s) the natural language query 302 is input into the multi-modal model 306 along with an annotated image of the updated GUI 304B, i.e., the annotated image of the current GUI after the update of the previous iteration. The multi-modal model 306 processes the input query 302 and the annotated image 304B for the iteration to generate a set of output data 308B for the iteration that comprises an action for the iteration to be taken through the GUI and the index of an interactable element of the GUI at which the action is to be taken. The set of output data 308B for the iteration can be converted to instructions for the user device that cause the user device to execute the identified first action at the location corresponding to the index.

The iterations proceed until a termination condition is satisfied. A termination condition may, for example, be based on an output 308A, 308B of the multi-modal model 306, or some other model, that indicates that the target task has successfully been completed or cannot be completed without a further interaction from the user.

In some examples, during the sequence of iterations sensitive data (e.g., login details) may be required to be input via the GUI. In some such examples, the multi-modal model 306 may output data 308A, 308B that causes a request to be output to the user that asks the user to input the sensitive data manually via the GUI. In examples where the relevant GUI is running in the background (i.e., not actually displayed to the user), this GUI may be surfaced to the user with the request. Alternatively, the output data 308A, 308B may indicate that the action is input of sensitive data, and the system may retrieve the sensitive data (e.g., from a secure database) and automatically input it at the relevant location in the GUI.

In some examples, the sequence of actions can comprise actions taken through different applications. For example, one or more actions can be taken in a first application, and one or more applications taken in a second application (and, in some examples, further applications). In such examples the set of possible actions output by the model 306 can comprise actions relating to navigating between applications. Alternatively, navigation between applications may be based on performing atomic actions on navigation GUI elements, e.g., clicking on a minimized task, swiping up on a touchscreen, etc.

As an example, the user may request may be “Please copy the image of the cat to the end of the pet document”, i.e., a target task of copying an image in one application, e.g., a drawing tool or web browser, into a second application, e.g., a text document. The sequence of actions generated by the method 300 will, for example, comprise: selecting the image of the cat in the first application GUI, performing a copy action on the selected image, navigating the user interface to the GUI of the second application, selecting the “pet” document, scrolling the page to the end of the document, and performing a paste action at the end of the document.

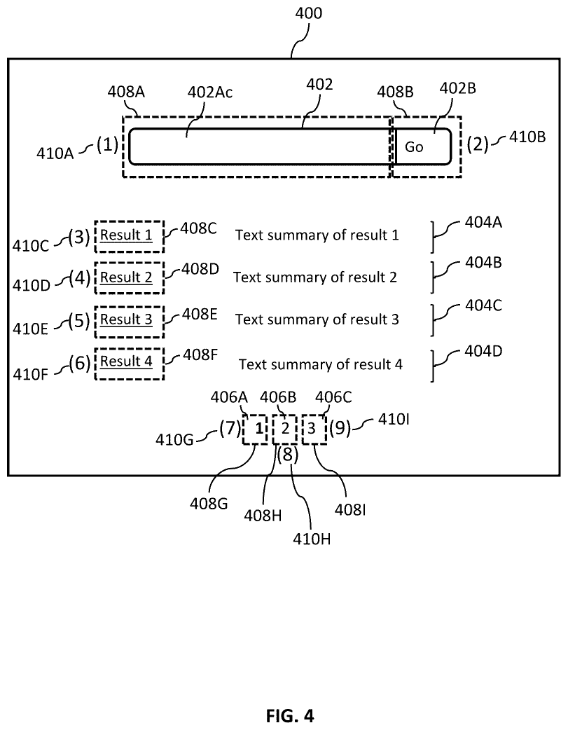

Turning now to FIG. 4, FIG. 4 illustrates an example of an annotated/marked-up image 400 of GUI. In the example shown, the GUI is a web browser showing a webpage of search results, though in alternative examples, the GUI can be an operating system GUI, a tool GUI, or the GUI of another type of application. Many other examples are possible.

The image of the GUI comprises a plurality of interactable GUI elements, including: a search bar 402 comprising a text input box 402A and a search initiation button 402B; a plurality of search results 404A-D that contain respective hyperlinks to further webpages; and plurality of navigation icons 406A-C for navigating to further pages of search results.

Each interactable element of the GUI has a corresponding bounding box 408A-I in the annotated image of the GUI, each of which is associated with a respective numerical index 410A-I. In the example shown, the bounding boxes 408A-I are dashed boxes, though the bounding boxes may, in other examples, be solid boxes, dotted boxes or the like. In the example shown, each index is adjacent to its respective bounding box, though in other examples at least some of the indices 410A-I may be contained within their respective bounding boxes 408A-I.

The annotated image of the GUI 400 for a web page may be generated from the DOM of the webpage. The DOM indicates the elements of the webpage and their respective locations when the web page is rendered. In some examples, the DOM may be edited directly to incorporate the bounding boxes and indices, i.e., the bounding boxes and their respective indices are added as additional elements to the DOM. Alternatively, a Dom interpretation API can be used to interpret the DOM and determine the locations of the bounding boxes and their respective indices.

Turning now to FIG. 5, a flowchart is depicted that illustrates an example method 500 for controlling a user interface based on NL input. The method 500 corresponds to the methods 200 described in relation to FIGS. 2 and 3. For convenience, the operations of the method 500 are described with reference to a system that performs the operations. This system of the method 500 includes one or more processors, memory, and/or other component(s) of computing device(s) (e.g., the NL-based response system 120 of FIG. 1). Moreover, while operations of the method 500 are shown in a particular order, this is not meant to be limiting. One or more operations may be reordered, omitted, and/or added.

At block 552, the system receives an input query indicative of a target task. The target task is a task that may be performed via a GUI of one or more applications, one or more tools and/or an operating system. The input query comprises an input text query. The query can be one formulated based on user interface input at a client device, such as typed input, voice input, selected input, etc. The input text query can be, for example, a voice query or a typed query. In some implementations, when the query includes content that is not in textual format, the system can convert the query to a textual format or other format. For example, if the query is a voice query the system can perform automatic speech recognition (ASR) to convert the voice query into textual format.

The target task is, in some examples, referred to explicitly on the input query, e.g., the input query explicitly requests that a task be performed. The target task is, in some examples, referred to implicitly on the input query, e.g., the input query comprises a request for information that requires a navigation and/or retrieval task to be performed.

At block 554, the system inputs, into a multi-modal ML model, input data comprising the natural language query and an image of the GUI. The image of the graphical user interface is annotated with data indicating the interactable elements of the GUI and a respective index for each interactable element, i.e., one or more indexed regions corresponding to respective interactable elements of the GUI.

For example, in some implementations, the image of the GUI comprises an overlay for the GUI. The overlay for the GUI indicates respective locations of the one or more indexed regions and respective indices of the one or more indexed regions, e.g., a bounding box for each interactable element and a respective index (e.g., a number) for each interactable element.

The annotated image of the GUI is, in some examples, derived from structural data indicating the layout of the GUI. The structural data indicates the relative locations of the various elements of the GUI and the properties of the elements, e.g., data indicating the interactable elements of the GUI and, in some examples, the interactions available at an interactable element. An example of such structural data is document object model (DOM) data for a webpage/browser. It will be appreciated that many other examples of structural data for a GUI can alternatively be used.

At block 556, the system processes, using the multi-modal ML model, the input data to generate a set of output data. The set of output data is indicative of an action to be taken via the user interface in furtherance of the target task and a corresponding index for an interactable element of the graphical user interface at which the action is to be taken.

In some implementations, the multi-modal ML model generates a plurality of candidate actions, each with a respective indexed location. Each action is further associated with a respective confidence score indicating a likelihood/probability that the action will advance the target task. In some implementations, the confidence score is generated by the multi-modal ML model, i.e., the output data further comprises the confidence score. In some implementations, the system uses a further ML model to generate the confidence scores. The confidence score for each candidate action is compared to a threshold confidence value/score. If no candidate action has a confidence score that exceeds threshold value, the system causes a request user input to be output via the or another GUI.

At block 558, the system causes the action to be taken via the GUI. The system may convert the output of the multi-modal ML model into instructions that can be executed to cause the actions to be taken via the user interface, e.g., to perform the indicated action at the target interactable element.

Operations 554-558 are, in some implementations, iterated until a termination condition is met. An example of a termination condition is the system determining that the target task has been completed. For example, the output data of a final iteration may be indicative that the target task has been completed. In response to such output data, the system may cause an indication that the target task has been completed to be output via the GUI. A further example of a termination condition is the system determining that the sequence of actions has reached a point where further user input is required to proceed, e.g., that the user is required to enter login details or perform some procedure (e.g., two-factor authentication) in order to proceed.

At each iteration, the system receives an updated image of the graphical user interface for the iteration corresponding to an updated graphical user interface after an action for the previous iteration has been taken. The updated image of the graphical user interface comprising one or more updated indexed regions corresponding to respective updated interactable elements of the updated graphical user interface. For example, the system regenerates an annotated image of the GUI after the action for the previous iteration has been taken.

The system then inputs, into the multi-modal machine-learning model, updated input data for the iteration. The updated input data for the iteration comprising the natural language query and the updated image of the graphical user interface for the iteration. The system processes, by/using the multi-modal machine-learning model, the updated input data for the iteration to generate a set of further output data for the iteration. The set of further output data for the iteration includes data that is indicative of a further action to be taken via the user interface in furtherance of the target task and a corresponding index for a further interactable element of the graphical user interface at which the further action is to be taken.

The system then causes the further action to be taken via the GUI.

Turning now to FIG. 6, a block diagram of an example computing device 610 that may optionally be utilized to perform one or more aspects of techniques described herein is depicted. In some implementations, one or more of a client device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some, or all, of the modules described herein. For example, the storage subsystem 724 may include the logic to perform selected aspects of the methods disclosed herein, as well as to implement various components depicted in FIG. 1.

These software modules are generally executed by processor 614 alone or in combination with other processors. Memory 625 used in the storage subsystem 624 can include a number of memories including a main random access memory (RAM) 60 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided and includes receiving a natural language query. The natural language query includes natural language data indicative of a target task performable via a graphical user interface. The method further includes inputting, into a multi-modal machine-learning model, input data including the natural language query and an image of the graphical user interface. The image of the graphical user interface includes one or more indexed regions corresponding to respective interactable elements of the graphical user interface. The method further includes processing, by the multi-modal machine-learning model, the input data to generate a set of output data, the set of output data indicative of an action to be taken via the user interface in furtherance of the target task and a corresponding index for an interactable element of the graphical user interface at which the action is to be taken. The method further includes causing the action to be taken via the graphical user interface.

These and other implementations of technology disclosed herein can optionally include one or more of the following features.

In some implementations, the method can further include, at each of one or more iterations subsequent to causing the action to be taken via the graphical user interface: receiving an updated image of the graphical user interface for the iteration corresponding to an updated graphical user interface after an action for the previous iteration has been taken, the updated image of the graphical user interface comprising one or more updated indexed regions corresponding to respective updated interactable elements of the updated graphical user interface; inputting, into the multi-modal machine-learning model, updated input data for the iteration, the input data for the iteration comprising the natural language query and the updated image of the graphical user interface for the iteration; processing, by the multi-modal machine-learning model, the updated input data for the iteration to generate a set of further output data for the iteration, the set of further output data for the iteration indicative of a further action to be taken via the user interface in furtherance of the target task and a corresponding index for a further interactable element of the graphical user interface at which the further action is to be taken; and causing the further action to be taken via the graphical user interface.

In some versions of those implementations, the action or the further action can include a request for a user to enter information into one or more of the interactable elements of the graphical user interface.

In some further versions of those implementations, the output data for a final iteration in the one or more iterations can be indicative that the target task is complete; and the further action for the final iteration can be an indication that the target task has been completed.

In additional or alternative versions of those implementations, the action can be caused to be performed in a graphical user interface of a first application; and one or more of the further actions can be performed in a graphical user interface of a second application.

In some implementations, the image of the graphical user interface can include an overlay for the graphical user interface, the overlay indicating respective locations of the one or more indexed regions and respective indices of the one or more indexed regions.

In some versions of those implementations, the overlay can include one or more bounding boxes, wherein each bounding box corresponds to a location of a respective interactable element of the graphical user interface.

In some implementations, the method can further include generating the image of the graphical user interface, where generating the one or more indexed regions from structural data can indicate a layout of the graphical user interface.

In some versions of those implementations, the structural data indicating a layout of the graphical user interface can be document object model, DOM, data.

In some implementations, causing the action to be taken via the graphical user interface can include performing the action at the interactable element indicated by the corresponding index.

In some implementations, processing, by the multi-modal machine-learning model, the input data to generate the set of output data can include: generating one or more of candidate actions, each candidate action associated with a respective confidence score; comparing each respective confidence score to a threshold confidence score; and in response to determining that no respective confidence score exceeds the threshold confidence score, causing a request for user input to be output via the or another graphical user interface.

In some implementations, the method can further include receiving a speech input; and generating, using a speech-to-text method, the natural language query from the speech input.

In some implementations, the action can include one or more of: a navigation action; a text entry; a cursor click; a touch input; a cursor click and drag; a deletion action; a cut action; a copy action; and/or a paste action.

In addition, some implementations include systems having one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to execute any of the aforementioned instructions. Some implementations also include one or more non-transitory computer readable storage media storing computer instructions executable by one or more processors to perform any of the aforementioned instructions. Some implementations also include a computer program product including instructions executable by one or more processors to perform any of the aforementioned instructions. Some implementations also include a method implemented by one or more processors to perform any of the steps of the aforementioned instructions.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving a natural language query, wherein the natural language query comprises natural language data indicative of a target task performable via a graphical user interface;
inputting, into a multi-modal machine-learning model, input data comprising the natural language query and an image of the graphical user interface, the image of the graphical user interface comprising one or more indexed regions corresponding to respective interactable elements of the graphical user interface;
processing, by the multi-modal machine-learning model, the input data to generate a set of output data, the set of output data indicative of an action to be taken via the user interface in furtherance of the target task and a corresponding index for an interactable element of the graphical user interface at which the action is to be taken; and
causing the action to be taken via the graphical user interface.

2. The method of claim 1, further comprising, at each of one or more iterations subsequent to causing the action to be taken via the graphical user interface:
receiving an updated image of the graphical user interface for the iteration corresponding to an updated graphical user interface after an action for the previous iteration has been taken, the updated image of the graphical user interface comprising one or more updated indexed regions corresponding to respective updated interactable elements of the updated graphical user interface;
inputting, into the multi-modal machine-learning model, updated input data for the iteration, the input data for the iteration comprising the natural language query and the updated image of the graphical user interface for the iteration;
processing, by the multi-modal machine-learning model, the updated input data for the iteration to generate a set of further output data for the iteration, the set of further output data for the iteration indicative of a further action to be taken via the user interface in furtherance of the target task and a corresponding index for a further interactable element of the graphical user interface at which the further action is to be taken; and
causing the further action to be taken via the graphical user interface.

3. The method of claim 2, wherein the action or the further action comprises a request for a user to enter information into one or more of the interactable elements of the graphical user interface.

4. The method of claim 3, wherein:
the output data for a final iteration in the one or more iterations is indicative that the target task is complete; and
the further action for the final iteration is an indication that the target task has been completed.

5. The method of claim 2, wherein:
the action is caused to be performed in a graphical user interface of a first application; and
one or more of the further actions are caused to be performed in a graphical user interface of a second application.

6. The method of claim 1, wherein the image of the graphical user interface comprises:
an overlay for the graphical user interface, the overlay indicating respective locations of the one or more indexed regions and respective indices of the one or more indexed regions.

7. The method of claim 6, wherein the overlay comprises:
one or more bounding boxes, wherein each bounding box corresponds to a location of a respective interactable element of the graphical user interface.

8. The method of claim 1, further comprising:
generating the image of the graphical user interface, comprising generating the one or more indexed regions from structural data indicating a layout of the graphical user interface.

9. The method of claim 8, wherein the structural data indicating a layout of the graphical user interface is document object model, DOM, data.

10. The method of claim 1, wherein causing the action to be taken via the graphical user interface comprises:
performing the action at the interactable element indicated by the corresponding index.

11. The method of claim 1, wherein processing, by the multi-modal machine-learning model, the input data to generate the set of output data comprises:
generating one or more of candidate actions, each candidate action associated with a respective confidence score;
comparing each respective confidence score to a threshold confidence score; and
in response to determining that no respective confidence score exceeds the threshold confidence score, causing a request for user input to be output via the or another graphical user interface.

12. The method of claim 1, further comprising:
receiving a speech input; and
generating, using a speech-to-text method, the natural language query from the speech input.

13. The method of claim 1, wherein the action comprises one or more of: a navigation action; a text entry; a cursor click; a touch input; a cursor click and drag; a deletion action; a cut action; a copy action; and/or a paste action.

14. A system comprising:
at least one processor; and
memory storing computer readable instructions that, when executed by the at least one processor, cause the at least one processor to be operable to:
receive a natural language query, wherein the natural language query comprises natural language data indicative of a target task performable via a graphical user interface;
input, into a multi-modal machine-learning model, input data comprising the natural language query and an image of the graphical user interface, the image of the graphical user interface comprising one or more indexed regions corresponding to respective interactable elements of the graphical user interface;
process, by the multi-modal machine-learning model, the input data to generate a set of output data, the set of output data indicative of an action to be taken via the user interface in furtherance of the target task and a corresponding index for an interactable element of the graphical user interface at which the action is to be taken; and
cause the action to be taken via the graphical user interface.

15. The system of claim 14, wherein the at least one processor is further operable to, at each of one or more iterations subsequent to causing the action to be taken via the graphical user interface:
receive an updated image of the graphical user interface for the iteration corresponding to an updated graphical user interface after an action for the previous iteration has been taken, the updated image of the graphical user interface comprising one or more updated indexed regions corresponding to respective updated interactable elements of the updated graphical user interface;
input, into the multi-modal machine-learning model, updated input data for the iteration, the input data for the iteration comprising the natural language query and the updated image of the graphical user interface for the iteration;
process, by the multi-modal machine-learning model, the updated input data for the iteration to generate a set of further output data for the iteration, the set of further output data for the iteration indicative of a further action to be taken via the user interface in furtherance of the target task and a corresponding index for a further interactable element of the graphical user interface at which the further action is to be taken; and
cause the further action to be taken via the graphical user interface.

16. The system of claim 15, wherein the action or the further action comprises a request for a user to enter information into one or more of the interactable elements of the graphical user interface.

17. The system of claim 16, wherein:
the output data for a final iteration in the one or more iterations is indicative that the target task is complete; and
the further action for the final iteration is an indication that the target task has been completed.

18. The system of claim 15, wherein:
the action is caused to be performed in a graphical user interface of a first application; and
one or more of the further actions are caused to be performed in a graphical user interface of a second application.

19. The system of claim 14, wherein the image of the graphical user interface comprises an overlay for the graphical user interface, the overlay indicating respective locations of the one or more indexed regions and respective indices of the one or more indexed regions, wherein the overlay comprises one or more bounding boxes, and wherein each bounding box corresponds to a location of a respective interactable element of the graphical user interface.

20. A non-transitory computer readable media comprising computer readable instructions that, when executed by a computer, cause the computer to:
receive a natural language query, wherein the natural language query comprises natural language data indicative of a target task performable via a graphical user interface;
input, into a multi-modal machine-learning model, input data comprising the natural language query and an image of the graphical user interface, the image of the graphical user interface comprising one or more indexed regions corresponding to respective interactable elements of the graphical user interface;
process, by the multi-modal machine-learning model, the input data to generate a set of output data, the set of output data indicative of an action to be taken via the user interface in furtherance of the target task and a corresponding index for an interactable element of the graphical user interface at which the action is to be taken; and
cause the action to be taken via the graphical user interface.
